(19) United States
(12) Patent Application Publication
(10) Pub. No.: US 2023/0401641 A1
(43) Pub. Date: Dec. 14, 2023

(54) SYSTEM AND METHOD TO COLLATERALIZE AND SECURITIZE MARKET-LINKED INVESTMENT VEHICLES

(71) Applicant: Longevity Market Assets, LLC, Orlando, FL (US)

(72) Inventor: Jay J. Jackson, Orlando, FL (US)

(21) Appl. No.: 17/836,163

(22) Filed: Jun. 9, 2022

(51) Int. Cl. G06Q 40/06; G06Q 30/02

(52) U.S. Cl. CPC G06Q 40/06; G06Q 30/0201

(57) ABSTRACT

A system for creating and implementing a market-linked investment vehicles secured by non-correlated or low-correlated assets, wherein the assets preferably appreciate during the term of the investment vehicle reducing the costs of the investment vehicles, and where the investment vehicle participates fully in the gains of an equity or similar market index but limits losses of principal up to a certain percentage of that index.

### FIELD OF THE INVENTION

The invention relates generally to finance, and more particularly to market-linked investment vehicles secured by non-correlated or low-correlated assets.

### BACKGROUND OF THE INVENTION

Lower interest rates, rapid inflation, and narrow credit spreads have traditionally forced fixed-income investors to undertake significant risk to earn even modest returns. Such investments are also vulnerable to fiscal and monetary policy errors by government and regulators. While principal-protected notes, reverse convertible notes, and leveraged notes have provided some mitigation to fixed-income investors, a need exists for a new market-linked investment vehicle that limits risk.

### SUMMARY OF THE INVENTION

In view of the aforementioned deficiencies and inadequacies in the existing investment vehicles, an objective of this invention is to provide a new type of structured note, designed to give investors uncapped exposure to an equity index while protecting against loss of a significant portion of principal if the index declines. Particularly, the invention provides system and method for collateralizing and securitizing market-linked investment vehicles secured by non-correlated assets.

In one aspect of the invention, the system, referred to the LMATTS™ system, implements market-linked investments that utilize insurance backed assets as collateral to provide the investor exposure to increases in S&P 500 ® Index while simultaneously limiting the investor's risk from decreases in value in the underlying index. To accomplish this, the LMATTS™ system utilizes market stress analytics to value and predict the returns from the underlying collateral, providing an appreciating collateral base to counter market-based decreases in the market-linked investment.

In one aspect, the system for creating a market-linked investment vehicle secured by non-correlated assets comprising a note payable upon its maturity; wherein said note's return is based upon the increase in a specified market index or other measure of market performance; aid note provides a buffer for negative performance up to a certain percentage of a specified market index or other measure of market performance; aid note is collateralized by non-correlated assets; and such non-correlated assets appreciate over the term of the note.

In one embodiment, the buffer is 40%.

In one embodiment, the non-correlated assets comprise a portfolio of insurance-based assets.

In one embodiment, the insurance-based assets comprise longevity assets.

In one embodiment, the non-correlated assets comprise a portfolio of real property assets.

In one embodiment, the real property assets comprise interests in real estate investment trusts.

In one embodiment, the non-correlated assets comprise a portfolio of alternative assets.

In one embodiment, the alternative assets comprise cryptocurrency.

In one embodiment, the alternative assets comprise privately-issued debt.

In another aspect, the system for creating a market-linked investment vehicle secured by low-correlated assets, comprising a note payable upon its maturity; wherein said note's return is based upon the increase in a specified market index or other measure of market performance; said note provides a buffer for negative performance up to a certain percentage of a specified market index or other measure of market performance; said note is collateralized by low-correlated assets; and such low-correlated assets appreciate over the term of the note.

In one embodiment, the buffer is 40%.

In one embodiment, the low-correlated assets comprise a portfolio of insurance-based assets.

In one embodiment, the insurance-based assets comprise longevity assets.

In one embodiment, the low-correlated assets comprise a portfolio of real property assets.

In one embodiment, the real property assets comprise interests in real estate investment trusts.

In one embodiment, the low-correlated assets comprise a portfolio of alternative assets.

In one embodiment, the alternative assets comprise cryptocurrency.

In one embodiment, the alternative assets comprise privately-issued debt.

These and other aspects of the present invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and, together with the written description, serve to explain the principles of the invention. The same reference numbers may be used throughout the drawings to refer to the same or like elements in the embodiments.

FIG. 1 shows the rolling 3-year average returns for the S&P 500 from 1928-2021.

FIG. 2 shows schematically the LMATTS™ system embodiment's policy purchase process.

FIG. 3 shows schematically the longevity analysis portion of the LMATTS™ system embodiment's policy purchase process.

FIG. 4 shows schematically the valuation and risk assessment portion of the LMATTS™ system embodiment's policy purchase process.

FIG. 5 shows a chart demonstrating how the baseline survival curve differs from the mortality adjusted curve.

### DETAILED DESCRIPTION OF EXEMPLARY EMBODIMENTS OF THE INVENTION

The invention will now be described more fully hereinafter with reference to the accompanying drawings, in which an exemplary embodiment of the invention is shown. This invention may, however, be embodied in many different forms and should not be construed as limited to the embodiment set forth herein. Rather, this embodiment is provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this invention, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

The systems and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in the example embodiment, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

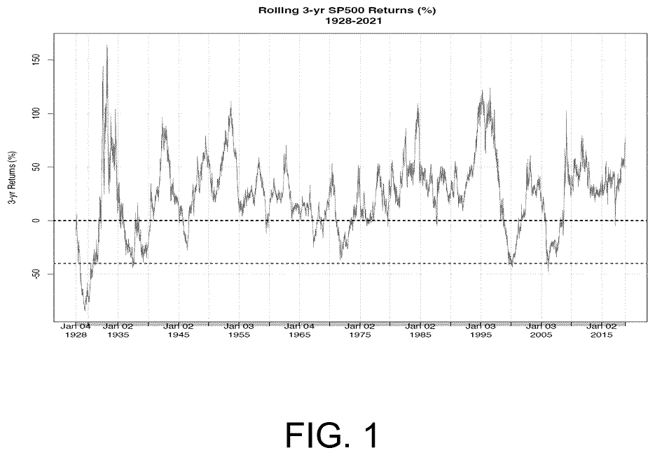

The Longevity Market Assets Target Term Series (“LMATTS™”) system of the invention provides a novel collateralized market-linked investment, designed to give investors uncapped exposure to the S&P 500 Index (S&P 500) for 3-years, while protecting against loss of principal up to 40% of that Index's decline. For this embodiment, the S&P 500 is chosen, given its propensity for positive returns over a three-year term. FIG. 1 sets forth in chart form the rolling 3-year average returns for the S&P 500 from 1928-2021. It should be noted that the term may be changed to 1-year, 2-years, 4-years, 5-years, or the likes.

In particular, the LMATTS™ system provides a structured note secured by low- or non-correlating longevity assets (the “LMATTS™note”). As is known in the industry, longevity assets generally include investment grade insurance liabilities. The LMATTS™ notes may be issued to accredited investors through a private placement memorandum or other applicable disclosures. Proceeds from the issuance of the LMATTS™ notes may then be used to purchase fixed life settlement policies, annuities, and other mortality-based longevity related assets.

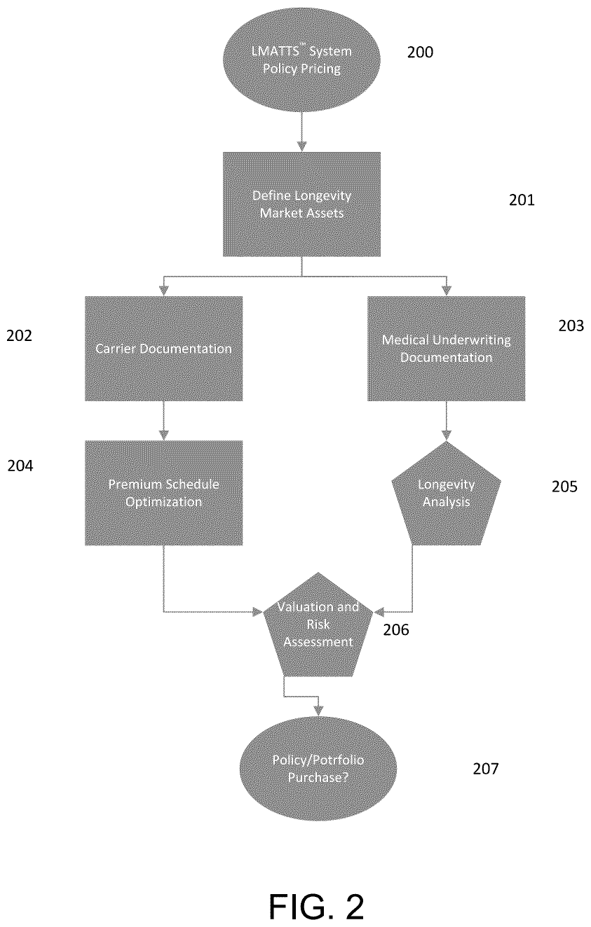

An exemplary procedure to analyze longevity assets that may be utilized as collateral for the LMATTS™ notes is set forth in FIG. 2. As shown in FIG. 2, the LMATTS™ pricing system 200 first defines a pool of potential longevity market assets 201. These potential longevity assets 201 are then analyzed individually based upon two separate criteria: carrier documentation 202 and medical underwriting documentation 203.

The carrier documentation 202 undergoes a policy premium schedule optimization analysis 204, which analyzes the life expectancy mean (“LE”) of the insured, adjusts the LE for various risk factors and generates a survival curve for the insured using the risk-adjusted LE.

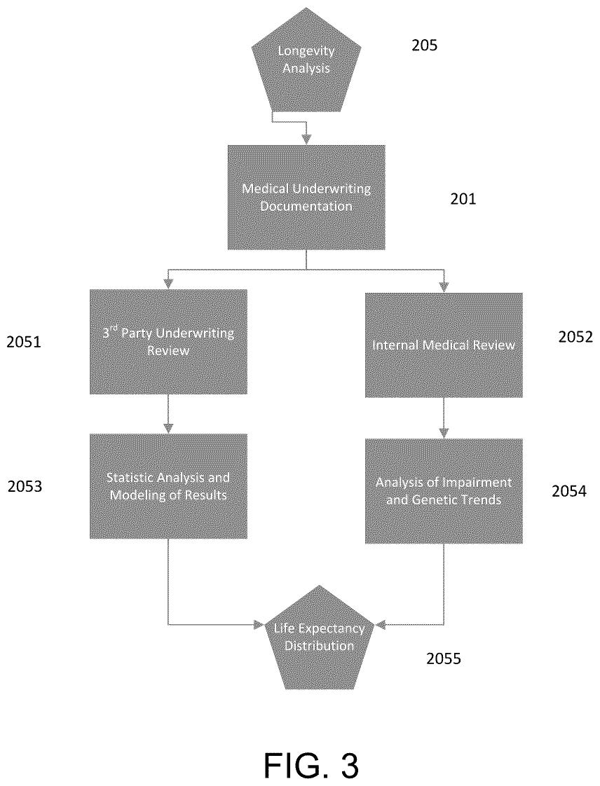

The medical underwriting documentation 203 undergoes a longevity analysis 205, as described in FIG. 3. As shown in FIG. 3, the longevity analysis 205 includes both a third-party underwriting review 2051 and an internal medical review 2052. The third-party underwriting review 2051 includes a statistical analysis and modeling of results 2053. The internal medical review 2052 includes an analysis of impairment and genetic trends 2054. The statistical analysis and modeling of results 2053 and analysis of impairment and genetic trends 2054 are utilized to develop a life expectancy distribution 2055.

The LE is generated based upon a case-by-case analysis of the insured 2054, including, e.g., age, gender, impairment, family history. For a given policy, the correct baseline mortality table, based upon gender and smoking status, is obtained. A monthly death probability (DPₘₒₙₜₕ) is calculated based upon the yearly death probabilities from the baseline mortality table (DP_{year}) using the equation: DPₘₒₙₜₕ=(DP_{year})^{1/12}. This calculation is performed for each month for the insured up to age 120 and utilized to calculate baseline survival probabilities (SP) using the equation: SP_{current month}=SP_{previous month}*(1=DP_{current month}). A baseline LE survival curve is calculated as the sum of all survival probabilities where n is the number of months of survival probability greater than 0 and k is the current month using the equation: LE=Σₖ₌₀ⁿSPₖ.

The baseline survival curve is then used to calculate a mortality adjusted LE, based upon the resulting LE selected. The mortality adjusted LE is calculated by applying a mortality rating (MR) to the baseline survival curve. The following calculations are repeated iteratively until the mortality adjusted LE equals the risk-adjusted LE:

DP_{month, adjusted}=DPₘₒₙₜₕ*MR a.

SP_{current month, adjusted}=SP_{previous month, adjusted}*(1−DP_{current month, adjusted}) b.

LE_{adjusted}=Σₖ₌₀ⁿSP_{k, adjusted}. c.

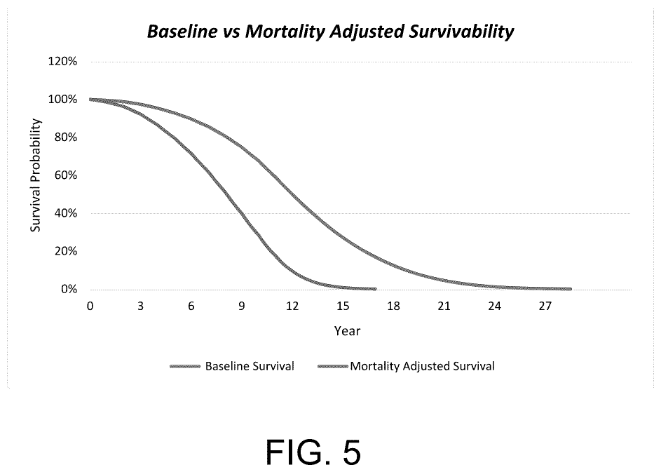

FIG. 5 is a chart demonstrating how the baseline survival curve differs from the mortality adjusted curve for an 80 year-old non-smoker for whom the baseline LE (when MR=1 or 100%) is 12.3 years and the risk-adjusted LE is 8 years, which results in a mortality rating of 3 or 300%. As shown in FIG. 5, the adjusted curve is much steeper and has significantly lower survival probability at any given time than our baseline curve.

If a policy has two insureds (one primary and one secondary) two survival probabilities curves must be generated, one for each insured with each having an independent risk-adjusted LE. Once each survival curve is derived independently, the two curves are frasierized to create a joint survival curve by applying the following calculation to each resulting month: SP_{joint, current month, adjusted}=SP_{primary, current month}+SP_{secondary, current month}−(SP_{primary, current month}*SP_{secondary, current month}).

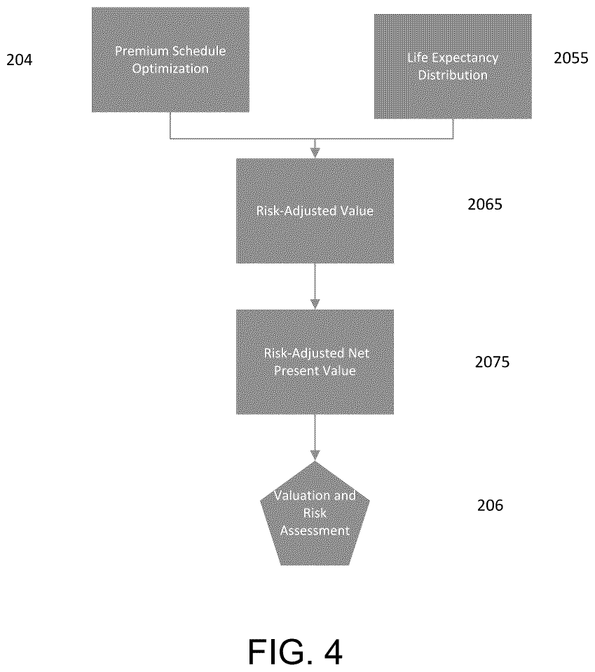

The survival curve generated in the policy premium schedule optimization analysis 204 and life expectancy distribution 2055 are then utilized in a valuation and risk assessment 206, as described in FIG. 4. As shown in FIG. 4, the valuation and risk assessment 206 generates a risk-adjusted value 2065.

In particular, net-present value (NPV) and expected tail loss at the 99th percentile (ETL99), a weighted average of NPVs in the worst 1% of scenarios, are calculated through iterative simulations as follows. A desired discount rate (DR_{year}) is selected based upon various policy risk metrics and a monthly discount rate is calculated as DRₘₒₙₜₕ=(1+DR_{year})^{1/12}−1. The simulation then generates a random number between 0 and 1, exclusive. The resulting simulated death under the policy in months from the value date is the first month in which the survival probability is less than the random number. For example, if the randomly generated number is and the insured has a 40% chance of survival in 100 months, the insured will have a simulated death of 100 months from the value date. A NPV of the simulation is then calculated, where n is the simulated death in months using the following calculation: NPV=Death Benefitₙ/(1+DRₘₒₙₜₕ)−Σₖ₌₀ⁿ⁻¹Premiumₖ/(1+DRₘₒₙₜₕ) k. The simulation is then repeated one-million (1,000,000) times to generate a precise distribution of NPVs with a sample size of 1,000,000, which is then averaged to generate a true NPV for the policy.

As the risk in a policy is present in the tail of the survival curve distribution, rather than at its mean, ETL99 provides a further refinement of the risk associated with a policy. To calculate ETL99, the results of the 1,000,000 scenarios are analyzed to determine the 10,000 lowest NPVs, the average of which is the ETL99 for the policy.

The risk of a policy in relation to its valuation is then analyzed as follows. A policy's NPV and ETL99 are utilized to generate the policy's risk-adjusted return on capital (RAROC), as follows: RAROC=NPV/ETL99. A smaller RAROC, i.e., where NPV<<|ETL99|, indicates significant risk in a policy that may not be reflected in just its NPV. Conversely, a larger RAROC, i.e., where NPV>>|ETL99|, indicates significant value beyond its NPV.

This same procedure may be utilized for a portfolio of policies, generating a risk-adjusted net present value of the portfolio.

Utilizing the analysis in FIG. 2, a decision is made regarding whether the longevity asset portfolio is appropriate for inclusion as collateral, e.g., the portfolio provides an appropriate risk-adjusted return on capital and will likely provide the requisite protection against index losses.

Upon the maturity of the LMATTS™ notes, the longevity assets may be sold and the proceeds distributed to each holder of a LMATTS™ note, who may receive her initial investment plus an amount equal to the positive performance of the S&P 500 Index, to the extent that the S&P 500 Index has achieved positive performance returns upon the scheduled maturity date. If the S&P 500 Index has not achieved positive performance returns upon the scheduled maturity date, the holder will be protected up to a certain percentage (“Buffer”) of the S&P 500 Index's loss.

In this embodiment, the LMATTS™ system's upside participation layer is designed to provide returns that will move one-to-one with the underlying S&P 500 Index while a separate layer of the LMATTS™ is designed to buffer losses by up to 40% if the index price experiences a loss during the investment period. After the underlying index has decreased in value by more than 40%, the investment will experience all subsequent losses on a one-to-one basis. In seeking to achieve this buffer, LMATTS™ system's downside risk mitigation may be achieved by purchasing a call and selling a put CFLEX Option to create a layered structure.

A unique feature of the LMATTS™ system is the inherent appreciation of the underlying collateral, longevity assets, over time. With every month that passes, the insureds on each policy are now one month older and, accordingly, the LEs that are used on each of the policies is constantly decreasing since, as a person lives longer, his life expectancy generally decreases. As a result, this appreciation in collateral may likely cover a not insubstantial amount of the annual costs of the LMATTS™ notes.

Another unique feature of the LMATTS™ system is that the LMATTS™ notes are illiquid. Unlike traditional bank-issued structured notes, there is no opportunity to redeem the LMATTS™ note until its maturity. At the maturity date, the LMATTS™ system will redeem the note, crediting the investor with the S&P 500 Index return for the 3-year period, as described above.

Similar economic modeling and analyses may be applied to other non-correlated or low-correlated assets serving as collateral for a collateralized market-linked investment as disclosed herein.

It should be noted that the system according to the embodiments of the invention may include hardware such as one or processors and storage media, and software instructing relevant hardware to perform data analysis so as to create and implement the market-linked investment vehicles secured by non-correlated or low-correlated assets. Yet another aspect of the invention provides a non-transitory computer readable storage medium/memory which stores computer executable instructions or program codes. The computer executable instructions or program codes enable the system to create a market-linked investment vehicles secured by non-correlated assets. The storage medium/memory may include, but is not limited to, high-speed random access medium/memory such as DRAM, SRAM, DDR RAM or other random access solid state memory devices, and non-volatile memory such as one or more magnetic disk storage devices, optical disk storage devices, flash memory devices, or other non-volatile solid state storage devices.

The foregoing description of the exemplary embodiment of the invention has been presented only for the purposes of illustration and description and is not intended to be exhaustive or to limit the invention to the precise forms disclosed. The embodiment was chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

What is claimed is:

1. A system for creating a market-linked investment vehicle secured by non-correlated assets, comprising:
a note payable upon its maturity;
wherein a return of said note is based upon the increase in a specified market index or other measure of market performance;
wherein said note provides a buffer for negative performance up to a certain percentage of a specified market index or other measure of market performance;
wherein said note is collateralized by non-correlated assets; and
wherein such non-correlated assets appreciate over the term of the note.

2. The system of claim 1, wherein the buffer is 40%.

3. The system of claim 1, wherein the non-correlated assets comprise a portfolio of insurance-based assets.

4. The system of claim 2, wherein the insurance-based assets comprise longevity assets.

5. The system of claim 1, wherein the non-correlated assets comprise a portfolio of real property assets.

6. The system of claim 5, wherein the real property assets comprise interests in real estate investment trusts.

7. The system of claim 1, wherein the non-correlated assets comprise a portfolio of alternative assets.

8. The system of claim 7, wherein the alternative assets comprise cryptocurrency.

9. The system of claim 7, wherein the alternative assets comprise privately-issued debt.

10. A system for creating a market-linked investment vehicle secured by low-correlated assets, comprising:
a note payable upon its maturity;
wherein a return of said note is based upon the increase in a specified market index or other measure of market performance;
wherein said note provides a buffer for negative performance up to a certain percentage of a specified market index or other measure of market performance;
wherein said note is collateralized by low-correlated assets; and
wherein such low-correlated assets appreciate over the term of the note.

11. The system of claim 10, wherein the buffer is 40%.

12. The system of claim 10, wherein the low-correlated assets comprise a portfolio of insurance-based assets.

13. The system of claim 12, wherein the insurance-based assets comprise longevity assets.

14. The system of claim 10, wherein the low-correlated assets comprise a portfolio of real property assets.

15. The system of claim 14, wherein the real property assets comprise interests in real estate investment trusts.

16. The system of claim 10, wherein the low-correlated assets comprise a portfolio of alternative assets.

17. The system of claim 16, wherein the alternative assets comprise cryptocurrency.

18. The system of claim 16, wherein the alternative assets comprise privately-issued debt.
